(19) United States
(12) Patent Application Publication
(10) Pub. No.: US 2017/0181176 A1
(43) Pub. Date: Jun. 22, 2017

(54) APPARATUS AND METHOD FOR ADAPTIVE TRANSMISSION PROCESSING BY DELAY

(71) Applicant: ELECTRONICS AND TELECOMMUNICATIONS RESEARCH INSTITUTE, Daejeon (KR)

(72) Inventor: Man Ho PARK, Daejeon (KR)

(73) Assignee: ELECTRONICS AND TELECOMMUNICATIONS RESEARCH INSTITUTE, Daejeon (KR)

(21) Appl. No.: 15/264,202

(22) Filed: Sep. 13, 2016

(30) Foreign Application Priority Data
Dec. 18, 2015 (KR) 10-2015-0181432
May 17, 2016 (KR) 10-2016-0059984

(51) Int. Cl. H04W 72/08; H04W 72/04

(52) U.S. Cl. CPC H04W 72/085; H04W 72/0446; H04W 84/12

(57) ABSTRACT

The present disclosure relates to an apparatus and a method for an adaptive transmission processing according to a transmission delay. The apparatus includes: a weight setting unit configured to set a transmission delay weight value for adjusting the transmission delay of a transmission packet according to a channel state, when transmitting the transmission packet to a destination node; a delay setting unit configured to set a unit transmission delay value for the transmission packet to be transmitted to the destination node, and to set a packet transmission delay value by applying the transmission delay weight value to the unit transmission delay value; and a controller configured to process to transmit the transmission packet to the destination node based on the packet transmission delay value, and to stop transmission of the transmission packet when a transmission number of the transmission packet reaches a predefined maximum number of transmission.

### CROSS-REFERENCE TO RELATED APPLICATION

This application claims the benefit of priority to Korean Patent Application 10-2015-0181432, filed on Dec. 18, 2015 in the Korean Intellectual Property Office and Korean Patent Application 10-2016-0059984, filed on May 17, 2016 in the Korean Intellectual Property Office, the disclosure of which is incorporated herein in its entirety by reference.

### BACKGROUND OF THE INVENTION

Field of the Invention

The present disclosure relates to an apparatus and a method for an adaptive transmission processing according to a transmission delay.

Description of the Related Art

Recently, as a wireless communication system is developed, an attention in a communication service with a high transmission rate is paid, and thus, a communication service using an ultra high frequency band is developed.

The ultra high frequency band is characterized by having a different frequency band from a low frequency band utilized in an existing communication service. Accordingly, a research on a propagation path, a transmittance property, and an interference property is accomplished to provide an efficient and reliable communication service.

In particular, it is reported that the communication service using a ultra high frequency band experiences a dynamic obstacle located on a communication path, a degradation of signal quality caused by shadowing, and a blocking of signal, in comparison with a communication service using a low bandwidth.

In addition, the communication service using a ultra high frequency band experiences a temporary signal attenuation caused by a moving object or a surrounding pedestrian located in the vicinity of a service user, thereby, a communication disconnection frequently occurs to degrade the quality of service used by a user.

Accordingly, it is required to provide a method of utilizing restricted communication resources effectively and usefully when using the communication service using a ultra high frequency band and preventing a frequent communication disconnection.

### SUMMARY OF THE INVENTION

The present disclosure has been made in view of the above problems, and provides an apparatus and a method for an adaptive transmission processing according to a transmission delay capable of adaptively adjusting a transmission delay for each transmission degree for a packet to be transmitted by putting weight when using a communication service using a ultra high frequency band, thereby, effectively treating a processing and a delay for a reconnection of the communication service caused by a temporary signal attenuation that may occur frequently.

In accordance with an aspect of the present disclosure, an apparatus for an adaptive transmission processing according to a transmission delay includes: a weight setting unit configured to set a transmission delay weight value for adjusting the transmission delay of a transmission packet according to a channel state, when transmitting the transmission packet to a destination node; a delay setting unit configured to set a unit transmission delay value for the transmission packet to be transmitted to the destination node, and to set a packet transmission delay value by applying the transmission delay weight value to the unit transmission delay value; and a controller configured to process to transmit the transmission packet to the destination node based on the packet transmission delay value, and to stop transmission of the transmission packet when a transmission number of the transmission packet reaches a predefined maximum number of transmission. The weight setting unit adjusts to increase the transmission delay weight value when the channel state for transmitting the transmission packet to the destination node is less than a reference value, and adjusts to decrease the transmission delay weight value when the channel state is the reference value or more. The delay setting unit increases or decreases the packet transmission delay value in proportion to an adjusted transmission delay weight value, when the transmission delay weight value is adjusted to increase or decrease when retransmitting the transmission packet. The delay setting unit resets the packet transmission delay value by applying the adjusted transmission delay weight value to a previously set packet transmission delay value when retransmitting the transmission packet. The weight setting unit selects any one of predefined weight candidates to set as an initial transmission delay weight value, when initially transmitting the transmission packet. The weight setting unit determines the channel state by using at least one of an error rate and a rate of change per unit time for a corresponding channel, a transmission delay expiration frequency per unit time, and a retransmission frequency per unit time. The delay setting unit selects any one of a set of transmission delay combination values as a unit transmission delay value for transmitting a corresponding transmission packet.

In accordance with another aspect of the present disclosure, a method for an adaptive transmission processing according to a transmission delay includes: setting a unit transmission delay value for a transmission packet to be transmitted to a destination node and an initial transmission delay weight value, and setting a packet transmission delay value by applying the transmission delay weight value to the unit transmission delay value; transmitting the transmission packet to the destination node based on the packet transmission delay value; adjusting the transmission delay weight value according to a channel state and resetting the packet transmission delay value by applying the adjusted transmission delay weight value, when a response signal for the transmitted transmission packet is not received; and retransmitting the transmission packet based on the reset packet transmission delay value. Retransmitting the transmission packet includes performing transmission of the transmission packet until a transmission number of the transmission packet reaches a predefined maximum number of transmission when a response signal for the transmitted packet transmission is not received, and stopping the transmission of the transmission packet when the transmission number of the transmission packet reaches the maximum number of transmission. Resetting the packet transmission delay value includes adjusting to increase the transmission delay weight value when the channel state for transmitting the transmission packet to the destination node is less than a reference value, and adjusting to decrease the transmission delay weight value when the channel state is the reference value or more. Resetting the packet transmission delay value includes determining the channel state by using at least one of an error rate and a rate of change per unit time for a corresponding channel, a transmission delay expiration frequency per unit time, and a retransmission frequency per unit time. Resetting the packet transmission delay value includes increasing or decreasing the packet transmission delay value in proportion to an adjusted transmission delay weight value, when the transmission delay weight value is adjusted to increase or decrease. Resetting the packet transmission delay value includes resetting the packet transmission delay value by applying the adjusted transmission delay weight value to a previously set packet transmission delay value. Setting a packet transmission delay value includes selecting any one of a set of transmission delay combination values as a unit transmission delay value for transmitting a corresponding transmission packet. Setting a packet transmission delay value includes selecting any one of predefined weight candidates to set as an initial transmission delay weight value, when initially transmitting the transmission packet.

### BRIEF DESCRIPTION OF THE DRAWINGS

The objects, features and advantages of the present disclosure will be more apparent from the following detailed description in conjunction with the accompanying drawings, in which:

FIG. 1 is a block diagram illustrating a configuration of an apparatus for an adaptive transmission processing according to a transmission delay according to an embodiment of the present disclosure;

FIG. 2 is a diagram illustrating an example for explaining a packet transmission delay value setting operation according to an embodiment of the present disclosure;

FIG. 3 is a diagram illustrating an example for explaining an adaptive transmission process operation according to a transmission delay according to an embodiment of the present disclosure;

FIG. 4 is a flowchart illustrating an operation flow for a method for an adaptive transmission processing according to a transmission delay according to an embodiment of the present disclosure; and

FIG. 5 is a block diagram illustrating a configuration of a computing system applying an apparatus according to an embodiment of the present disclosure.

### DETAILED DESCRIPTION OF EXEMPLARY EMBODIMENTS

Exemplary embodiments of the present disclosure are described with reference to the accompanying drawings in detail. The same reference numbers are used throughout the drawings to refer to the same or like parts. Detailed descriptions of well-known functions and structures incorporated herein may be omitted to avoid obscuring the subject matter of the present disclosure.

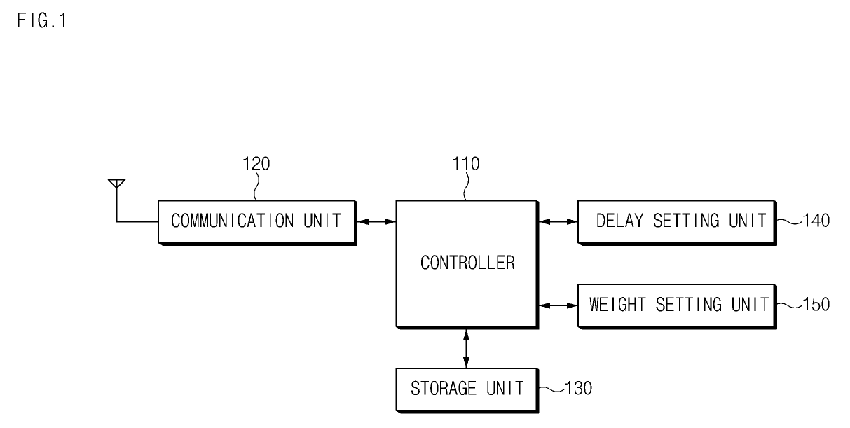

FIG. 1 is a block diagram illustrating a configuration of an apparatus for an adaptive transmission processing according to a transmission delay according to an embodiment of the present disclosure.

Referring to FIG. 1, the apparatus for an adaptive transmission processing according to a transmission delay according to an embodiment of the present disclosure (hereinafter, referred to as “adaptive transmission processing apparatus”) may include a controller 110, a communication unit 120, a storage unit 130, a delay setting unit 140, and a weight setting unit 150. Here, the controller 110 may process a signal transmitted between each unit of the adaptive transmission processing apparatus.

The communication unit 120 may serve to transmit a transmission packet to a destination.

Thus, the communication unit 120 may include a module for wireless Internet access or a module for short-range communication. Here, a wireless Internet technology may include a wireless LAN (WLAN), Wireless Broadband (Wibro), Wi-Fi, World Interoperability for Microwave Access (WiMAX), High Speed Downlink Packet Access (HSDPA), and the like. In addition, a short-range communication technology may include Bluetooth, ZigBee, Ultra Wideband (UWB), Radio Frequency Identification (RFID), Infrared Data Association (IrDA), and the like.

The communication unit 120 may include a module for wired communication. Here, a wired communication technology may include a Universal Serial Bus (USB) communication.

The storage unit 130 may store a data, a program, and the like necessary for the operation of the adaptive transmission processing apparatus. For example, the storage unit 130 may store a preset unit transmission delay value, a transmission delay weight value, and a packet transmission delay value. In addition, the storage unit 130 may store an algorithm for setting the preset unit transmission delay value, the transmission delay weight value, and the packet transmission delay value and/or an algorithm for controlling the transmission delay weight value variably.

Here, the storage unit 130 may include at least one of a storage media such as a flash memory type, a hard disk type, a multimedia card micro type, a card type memory (e.g., SD or XD memory, etc.), a magnetic memory, a magnetic disk, an optical disk, Random Access Memory (RAM), Static Random Access Memory (SRAM), Read-Only Memory (ROM), Programmable Read-Only Memory (PROM), Electrically Erasable Programmable Read-Only Memory (EEPROM).

When a transmission packet to be transmitted to a destination node is generated, the delay setting unit 140 may select a unit transmission delay value for a corresponding transmission packet to set a unit transmission delay value (Dstep) for a transmission delay timer.

Here, assuming that a set of adaptable transmission delay combination values is {tc1,tc2, . . . ,tcN}, the adaptive transmission processing apparatus may select any one of the set of transmission delay combination values as a unit transmission delay value (Dstep) for transmitting a current packet.

The weight setting unit 150 may set a transmission delay weight value (Wstep). Here, the transmission delay weight value (Wstep) is a value for adjusting the transmission delay adaptively according to a channel state, and may be set to an arbitrary value when transmitting a transmission packet.

In other words, the weight setting unit 150 may set an initial transmission delay weight value for the transmission packet to an arbitrary value. For example, in the case of setting the initial transmission delay weight value, the weight setting unit 150 may set the initial transmission delay weight value (Wstep, 0) by selecting one of predefined weight value candidates {wc₀, wc₁, . . . , wc_{N}|wcₙ₊₁>wcₙ, w_{c0}≧1}, for example, by selecting wc₀.

Meanwhile, when retransmitting a transmission packet, the weight setting unit 150 may adjust the transmission delay weight value for the transmission packet to be retransmitted according to the channel state.

Here, the weight setting unit 150 may determine the channel state in consideration of an error rate and a rate of change per unit time, a transmission delay expiration frequency per unit time, a retransmission frequency per unit time, and the like.

When it is determined that the channel state is not good, i.e., under a reference value, the weight setting unit 150 may adjust to increase the transmission delay weight value so as to increase the packet transmission delay value. Meanwhile, when it is determined that the channel state is good, i.e., a reference value or more, the weight setting unit 150 may adjust to decrease the transmission delay weight value so as to decrease the packet transmission delay value.

At this time, when the transmission delay weight value is set by the weight setting unit 150, the delay setting unit 140 may set a packet transmission delay value by applying the transmission delay weight value to a unit transmission delay value.

When the weight setting unit 150 adjusts the transmission delay weight value to increase or decrease, the delay setting unit 140 may reset a packet transmission delay value by applying the adjusted transmission delay weight value to the unit transmission delay value.

Therefore, the packet transmission delay value may be increased or decreased by the transmission delay weight value. Here, the packet transmission delay value (Dstep, trial) may be calculated by using the following [Equation 1].

D_{step,trial}=Dₛₜₑₚ·Wₛₜₑₚ^{trial-1} [Equation 1]

In Equation 1, D_{step,trial}denotes a packet transmission delay value, Dₛₜₑₚ denotes a unit transmission delay value, Wₛₜₑₚ^{trial-1} denotes a transmission delay weight value according to the number of packet transmission, and trial means the number of transmission.

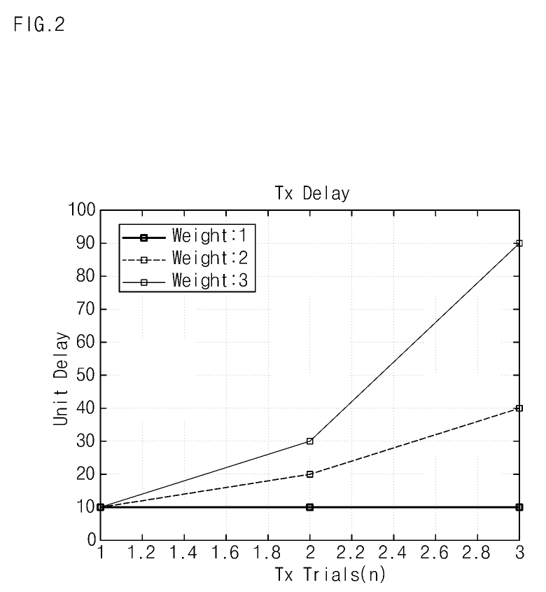

FIG. 2 is an example for a change in the packet transmission delay value according to the transmission delay weight value.

As shown in FIG. 2, when the unit transmission delay value (unit delay) is 10, during the first packet transmission, the unit transmission delay value may become a packet transmission delay value (Tx Delay) regardless of the transmission delay weight value.

However, in the case of retransmitting the transmission packet, the packet transmission delay value may be increased to 10, 20, 30 according to the transmission delay weight value 1, 2, 3. Further, in the case of the third transmission, it can be seen that the packet transmission delay value may be increased to 10, 40, 90 by applying the transmission delay weight value 1, 2, 3 to the packet transmission delay value 10, 20, 30 during the second packet transmission.

Thus, packet transmission delay value may be increased or decreased by the transmission delay weight value.

The controller 110 may transmit the transmission packet to a destination node based on the packet transmission delay value set by the delay setting unit 140.

At this time, the controller 110 may check whether a response signal for the packet transmission from the destination node is received, and when the response signal is not received within a predefined time, it is determined that the packet transmission is failed. Thus, the controller 110 may notify the retransmission of the transmission packet to the delay setting unit 140 and the weight setting unit 150.

When the packet transmission delay value to which the adjusted transmission delay weight value is applied is set in the weight setting unit 150, the controller 110 may retransmit the transmission packet to the destination node based on the reset packet transmission delay value.

When the number of transmission for the transmission packet reaches a previously set maximum transmission number, the controller 110 may terminate the transmission of a corresponding transmission packet in order to avoid the performance degradation of the system due to a frequent retransmission, and may transmit the next transmission packet.

In this case, the controller 110 may report the transmission failure of the transmission packet to a user or an administrator.

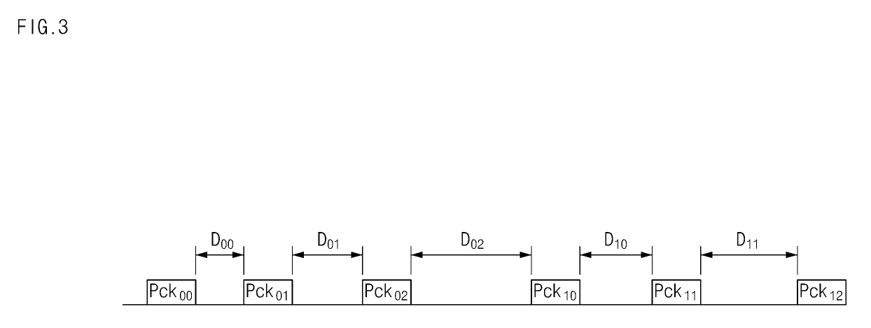

FIG. 3 is a diagram illustrating an example for explaining an adaptive transmission process operation according to a transmission delay according to an embodiment of the present disclosure.

Referring to FIG. 3, the adaptive transmission processing apparatus may transmit a transmission packet ‘Pck00’. At this time, when a response signal is not received, the transmission packet ‘Pck01’ may be retransmitted after D00 which is set to the packet transmission delay value.

When the response signal is not received even after the ‘Pck01’ is retransmitted, the adaptive transmission processing apparatus may retransmit the transmission packet ‘Pck02’ after D01 which is set to the packet transmission delay value.

Here, if the limit of the packet transmission is set to three times, the adaptive transmission processing apparatus may terminate the retransmission when the response signal for the transmission packet ‘Pck02’ is not received, and may transmit the next transmission packet ‘Pck10’.

At this time, when retransmitting the transmission packet, the adaptive transmission processing apparatus may adjust the transmission delay weight value to increase or decrease according to the channel state so that it is possible to increase or decrease the gap of the D01 and/or D02.

A more detailed description of the operation flow of the apparatus according to the present disclosure configured as described above is as follows.

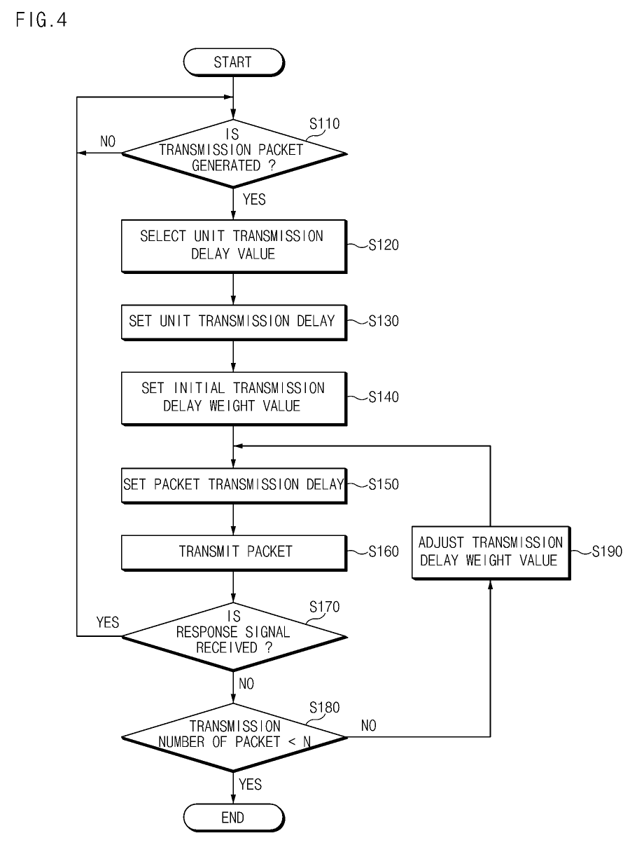

FIG. 4 is a flowchart illustrating an operation flow for a method for an adaptive transmission processing according to a transmission delay according to an embodiment of the present disclosure.

As shown in FIG. 4, when a transmission packet is generated (S110), the adaptive transmission processing apparatus according to an embodiment of the present disclosure may select the unit transmission delay value for a corresponding transmission packet (S120), and may set a unit transmission delay value (Dstep) for the transmission delay timer (S130).

Here, assuming that a set of adaptable transmission delay combination values is {tc1, tc2,. . . , tcN}, the adaptive transmission processing apparatus may select any one of the set of transmission delay combination values as a unit transmission delay value (Dstep) for transmitting a current packet.

When the unit transmission delay value for the transmission packet is selected, the adaptive transmission processing apparatus may set an initial transmission delay weight value (S140).

For example, the adaptive transmission processing apparatus may set the initial transmission delay weight value by selecting one of predefined weight value candidates {wc₀, wc₁, . . . , wc_{N}|wcₙ₊₁>wcₙ, w_{c0}≧1}, for example, wc₀.

Then, the adaptive transmission processing apparatus may set the packet transmission delay value by using the unit transmission delay value set at step S130 and the initial transmission delay weight value set at step S140 (S150).

When the initial packet transmission delay value is set at step S150, the adaptive transmission processing apparatus may reflect the set initial packet transmission delay value set and may transmit a transmission packet (S160).

When a response signal is received after transmitting the transmission packet at step S160 (S170), the adaptive transmission processing apparatus may determine that the transmission packet is transmitted safely, and may perform the steps s110 to s160 with respect to the next generated transmission packet.

Meanwhile, when the response signal is not received after transmitting the transmission packet at step S160 (S170), the adaptive transmission processing apparatus may determine that the transmission packet is failed, and may transmit the retransmission packet again.

Here, the adaptive transmission processing apparatus may check the transmission number of the transmission packet, and terminate the transmission of the transmission packet, when the transmission number of the transmission packet corresponds to a pre-defined maximum transmission number (N) (S180).

When the transmission number of the transmission packet does not reach the pre-defined maximum transmission number (N) (S180), the adaptive transmission processing apparatus may adjust the transmission delay weight value according to the channel state for transmitting a corresponding transmission packet (S190).

Here, the adaptive transmission processing apparatus may determine the channel state through the error rate and the rate of change per unit time, the transmission delay expiration frequency per unit time, the retransmission frequency per unit time, and the like.

Then, the adaptive transmission processing apparatus may re-set the packet transmission delay value by applying the transmission delay weight value which is adjusted to increase or decrease according to the channel state through step S190 (S150).

At step S190 and S150, when it is determined that the channel state is not good, i.e., lower than a reference value, the adaptive transmission processing apparatus may adjust to increase the transmission delay weight value so as to increase the packet transmission delay value. Meanwhile, when it is determined that the channel state is good, i.e., a reference value or more, the adaptive transmission processing apparatus may adjust to decrease the transmission delay weight value so as to decrease the packet transmission delay value.

Thus, the adaptive transmission processing apparatus may retransmit the transmission packet by reflecting the reset packet transmission delay value (S160).

The transmission packet may be retransmitted up to a (N−1)-th retransmission through steps S150 to S190 until the response signal is received. In the case of attempting to performing a N-th retransmission, the adaptive transmission processing apparatus may stop the transmission of a corresponding transmission packet to avoid the degradation of the system due to frequent retransmissions, and may terminate the related operation.

Here, it is obvious that a value N which is a reference value to stop the retransmission may be adjusted in any degree according to an embodiment.

The adaptive transmission processing apparatus according to the transmission delay according to the present embodiment operates as in the above may be implemented as an independent hardware device type. Meanwhile, the adaptive transmission processing apparatus according to the transmission delay according to the present embodiment may be included to be driven in other hardware device such as a microprocessor or a general purpose computer system as at least one processor.

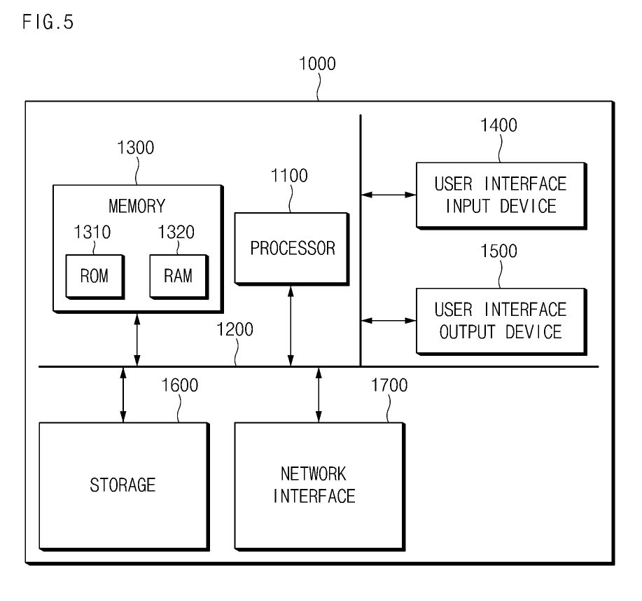

FIG. 5 is a block diagram illustrating a configuration of a computing system applying an apparatus according to an embodiment of the present disclosure.

Referring to FIG. 5, the computing system 1000 may include at least one processor 1100 which is connected via a bus 1200, memory 1300, an user interface input device 1400, an user interface output device 1500, a storage 1600, and a network interface 1700.

The processor 1100 may be a semiconductor device for performing a processing for instructions stored in a central processing unit (CPU) or the memory 1300 and/or the storage 1600. The memory 1300 and the storage 1600 may include various types of volatile and nonvolatile storage media. For example, the memory 1300 may include a Read Only Memory (ROM) 1310 and a Random Access Memory (RAM) 1320.

Thus, the steps of the method or the algorithm described in association with the embodiments disclosed herein may be directly implemented by a hardware, a software module, or a combination of the two executed by the processor 1100. The software module may reside in a storage medium (i.e., in the memory 1300 and/or the storage 1600) such as a RAM memory, a flash memory, a ROM memory, an EPROM memory, an EEPROM memory, a register, a hard disk, a removable disk, and CD-ROM. The exemplary storage medium may be coupled to the processor 1100, and the processor 1100 may read information from the storage medium and write information to the storage medium. Alternatively, the storage medium may be integrated in the processor 1100. The processor and the storage medium may reside in an application specific integrated circuit (ASIC). The ASIC may reside in a user terminal. Alternatively, the processor and the storage medium may reside in the user terminal as an individual component.

As described above, the embodiment of the present disclosure may reduce a temporary channel state degradation and unnecessary retransmissions that occur frequently when blocking a communication path, may effectively utilize limited communication resources, and may prevent the system performance degradation due to frequent communication reconnection, by adaptively adjusting a transmission delay for each transmission degree for a packet to be transmitted by putting weight when using a communication service using a ultra high frequency band.

Hereinabove, although the present disclosure has been described with reference to exemplary embodiments and the accompanying drawings, the present disclosure is not limited thereto, but may be variously modified and altered by those skilled in the art to which the present disclosure pertains without departing from the spirit and scope of the present disclosure claimed in the following claims.

What is claimed is:

1. An apparatus for an adaptive transmission processing according to a transmission delay, the apparatus comprising:
a weight setting unit configured to set a transmission delay weight value for adjusting the transmission delay of a transmission packet according to a channel state, when transmitting the transmission packet to a destination node;
a delay setting unit configured to set a unit transmission delay value for the transmission packet to be transmitted to the destination node, and to set a packet transmission delay value by applying the transmission delay weight value to the unit transmission delay value; and
a controller configured to process to transmit the transmission packet to the destination node based on the packet transmission delay value, and to stop transmission of the transmission packet when a transmission number of the transmission packet reaches a predefined maximum number of transmission.

2. The apparatus of claim 1, wherein the weight setting unit adjusts to increase the transmission delay weight value when the channel state for transmitting the transmission packet to the destination node is less than a reference value, and adjusts to decrease the transmission delay weight value when the channel state is the reference value or more.

3. The apparatus of claim 2, wherein the delay setting unit increases or decreases the packet transmission delay value in proportion to an adjusted transmission delay weight value, when the transmission delay weight value is adjusted to increase or decrease when retransmitting the transmission packet.

4. The apparatus of claim 2, wherein the delay setting unit resets the packet transmission delay value by applying the adjusted transmission delay weight value to a previously set packet transmission delay value when retransmitting the transmission packet.

5. The apparatus of claim 1, wherein the weight setting unit selects any one of predefined weight candidates to set as an initial transmission delay weight value, when initially transmitting the transmission packet.

6. The apparatus of claim 1, wherein the weight setting unit determines the channel state by using at least one of an error rate and a rate of change per unit time for a corresponding channel, a transmission delay expiration frequency per unit time, and a retransmission frequency per unit time.

7. The apparatus of claim 1, wherein the delay setting unit selects any one of a set of transmission delay combination values as a unit transmission delay value for transmitting a corresponding transmission packet.

8. A method for an adaptive transmission processing according to a transmission delay, the method comprising:
setting a unit transmission delay value for a transmission packet to be transmitted to a destination node and an initial transmission delay weight value, and setting a packet transmission delay value by applying the transmission delay weight value to the unit transmission delay value;
transmitting the transmission packet to the destination node based on the packet transmission delay value;
adjusting the transmission delay weight value according to a channel state and resetting the packet transmission delay value by applying the adjusted transmission delay weight value, when a response signal for the transmitted transmission packet is not received; and
retransmitting the transmission packet based on the reset packet transmission delay value.

9. The method of claim 8, wherein retransmitting the transmission packet comprises performing transmission of the transmission packet until a transmission number of the transmission packet reaches a predefined maximum number of transmission when a response signal for the transmitted packet transmission is not received, and stopping the transmission of the transmission packet when the transmission number of the transmission packet reaches the maximum number of transmission.

10. The method of claim 8, wherein resetting the packet transmission delay value comprises adjusting to increase the transmission delay weight value when the channel state for transmitting the transmission packet to the destination node is less than a reference value, and adjusting to decrease the transmission delay weight value when the channel state is the reference value or more.

11. The method of claim 10, wherein resetting the packet transmission delay value comprises determining the channel state by using at least one of an error rate and a rate of change per unit time for a corresponding channel, a transmission delay expiration frequency per unit time, and a retransmission frequency per unit time.

12. The method of claim 10, wherein resetting the packet transmission delay value comprises increasing or decreasing the packet transmission delay value in proportion to an adjusted transmission delay weight value, when the transmission delay weight value is adjusted to increase or decrease.

13. The method of claim 10, wherein resetting the packet transmission delay value comprises resetting the packet transmission delay value by applying the adjusted transmission delay weight value to a previously set packet transmission delay value.

14. The method of claim 8, wherein setting a packet transmission delay value comprises selecting any one of a set of transmission delay combination values as a unit transmission delay value for transmitting a corresponding transmission packet.

15. The method of claim 8, wherein setting a packet transmission delay value comprises selecting any one of predefined weight candidates to set as an initial transmission delay weight value, when initially transmitting the transmission packet.
